(19) United States
(12) Patent Application Publication
(10) Pub. No.: US 2025/0270054 A1
(43) Pub. Date: Aug. 28, 2025

(54) METHODS AND SYSTEMS FOR DETERMINING MOTION PROFILE DATA FOR A TRANSPORT SYSTEM

(71) Applicant: Schneider Electric Industries SAS, Rueil-Malmaison (FR)

(72) Inventors: Sebastian Diehm, Hasloch (DE); Sebastian Furth, Großrinderfeld (DE); Jürgen Heid, Altertheim (DE); Yiman Li, Würzburg (DE)

(73) Assignee: Schneider Electric Industries SAS, Rueil-Malmaison (FR)

(21) Appl. No.: 19/059,710

(22) Filed: Feb. 21, 2025

(30) Foreign Application Priority Data
Feb. 22, 2024 (EP) 24305289.1

(51) Int. Cl. B65G 43/00

(52) U.S. Cl. CPC B65G 43/00; B65G 2203/0291

(57) ABSTRACT

A method for determining motion profile data for a transport system is provided. The method comprises: determining first motion profile data based on a machine learning method, wherein the first motion profile data comprises information on a first segment of transport; and determining second motion profile data based on a movement of a further transport system, wherein the second motion profile data comprises information on a second segment of transport.

The present disclosure relates to methods and system for determining motion profile data for a transport system.

Transport systems may be used to transport or move items from one place to another, for example during manufacturing or packaging. Furthermore, the item may be manipulated, for example sealed or printed during the transport.

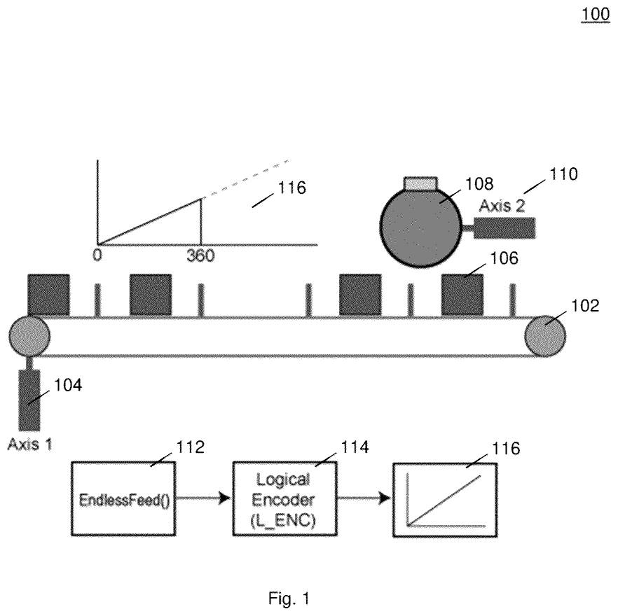

FIG. 1 shows an illustration of an exemplary transport system arrangement 100, where a transport system 102 with a first axis 104 transports a plurality of items 106, for example on a belt. A further transport system 108, with a second axis 110, interacts with the items 106 transported by the first transport system 102. In the example illustrated in FIG. 1, the further transport system 108 is a printing system, which transports a print (for example ink or color) to the items 106.

FIG. 1 demonstrates the machine-subsystem for printing application as well as the logical connection of the motion system. The physical or virtual master (e.g. representing the transport belt 102 and respectively the Servo-Drive/Motor subsystem 104 operating it) is running in an endless feed operation with continuous transport of the products/goods/materials.

Illustratively, a logical software object (named logical encoder 114) may be used to connect the motion master (leader) with the motion slave (follower) axis 102 and may be operated to transform the master-endless movement 112 to an input appropriate to the slave cyclic movement in the slaves coordinate system 116.

The motion slave (following axis 102) may subsequently be running its local movement cyclically with an electronic cam in the coordinate system 116 given in the example from 0 to 360 units (wherein user units may for example represent rotation or mm or any other application wide consistent unit definition). This may be operated in a way to synchronously move the printing unit 108 to the products/goods 106.

DE 10 2021/128 280 A1 discloses a container treatment system for treating containers. The container treatment system has a filling device for filling the containers and a planar drive system having a base element and a plurality of transport movement devices. The base element is connected to the filling device. The base element is designed to drain liquid that has leaked onto the top of the base element to a liquid collection zone of the container treatment system. Excessive contamination of the base element and thus of the container treatment system can be prevented by allowing leaked liquid to flow automatically to the liquid collection zone.

WO 2019/238 277 A1 discloses a method for identifying a load and/or wear of a transport element of a transport system with a long-stator linear motor, having the steps of: exciting a dynamic system consisting of the long-stator linear motor and the transport element according to at least one excitation pattern; capturing the movement profile of the transport element on account of the at least one excitation pattern; and capturing a temporal profile of a load current and/or of a load voltage of the long-stator linear motor according to the at least one excitation pattern by means of an integrated measuring apparatus of the long-stator linear motor; wherein a loading condition of the transport element is determined on the basis of the captured movement profile and the captured temporal profile of the load current and/or of the load voltage.

J. Wang et al., “Multi-Agent Reinforcement Learning for Active Voltage Control on Power Distribution Networks”, arXiv:2110.14300, is related to power networks, in particular to active voltage control in voltage grids, and formulates the active voltage control problem in the framework of Dec-POMDP and establishes an open-source environment.

The known methods lack a way to efficiently and reliable determine motion profiles also in cases where analytical solutions are not available.

It is an object of the invention to efficiently and reliably provide methods and system for determining motion profile data for a transport system.

These objects are accomplished with the features of claim 1 and with the features of claims, 12, 13, and 14.

A method for determining motion profile data for a transport system (for example a multicarrier system) has the features of claim 1. The method for determining motion profile data for a transport system comprises: determining first motion profile data based on a machine learning method, wherein the first motion profile data comprises information on a first segment of transport; and determining second motion profile data based on a movement of a further transport system, wherein the second motion profile data comprises information on a second segment of transport.

In other words, an overall motion profile may be determined, including one portion which is restricted based on a movement of another transport system, and one portion is less restricted and the motion profile for the less restricted portion is determined using a machine learning method.

The machine learning method may include an artificial neural network. The machine learning method may include a reinforcement learning method.

The second segment may be provided before the first segment, or the second segment may be provided after the first segment. According to various embodiments, more than one first segment and/or more than one second segment may be provided.

The second motion profile data may be determined so that the transport system moves in line with the further transport system (for example during the second segment of transport). Thus, efficient handling of any items moved by the transport system and subject to any further processing using the further transport system may be provided.

The second motion profile data is determined so that a handover of an item carried by the further transport system is provided to the transport system (for example so that the second segment is a segment of handover from the transport system to the further transport system). This may provide seamless handover of the item from the transport system to the further transport system or vice versa.

The first motion profile data and/or the second motion profile data may be defined using a spline. This may allow efficient representation of the first and/or second motion profile data and the motions represented by the first and/or second motion profile may be smooth.

The first motion profile data and/or the second motion profile data may be defined using an array of positions. This may allow efficient representation of the first and/or second motion profile data.

The first motion profile data is determined based on minimizing a time. For example, the first motion profile data may represent a motion which provides a minimum time to a target.

The first motion profile data may be determined based on minimizing an energy consumption. For example, the first motion profile data may represent a motion which provides an energy optimized movement.

The first motion profile data may be determined based on minimizing slosh of a liquid provided in a container to be transported by the transport system. For example, the first motion profile data may represent a motion with reduced slosh or even without slosh of a liquid provided in a container to be moved by the transport system.

The first motion profile data may provide at least one of an acceleration, a deceleration, or a return to a pre-determined position.

The further transport system may be configured to move a tool to manipulate an item carried by the transport system. The tool may include or may be a printer, and/or a knife, and/or a tool to add a further item to the item. For example, the item may be a beverage can body, and the further item may be a can lid.

A non-transitory computer-readable medium has the features of claim 12. The non-transitory computer-readable medium may comprise instructions which, when executed by a computing system, make the computing system carry out one or more steps of one of the methods as described herein.

A data processing apparatus has the features of claim 13. The data processing apparatus may be configured to carry out one or more steps of one of the methods as described herein. The data processing apparatus may also be referred to as control unit.

A transport system has the features of claim 14. The transport system may comprise a control unit (for example the control unit of claim 13) configured to determine a motion profile data for the control system based on one of the methods as described herein.

The transport may be configured as a multicarrier system. The multicarrier system may include a plurality of linear motors which are provided in a series, and a guidance rail, wherein a transport element may be moved along the guidance rail.

In the following, embodiments of the invention will be explained with reference to the drawings, in which

FIG. 1 shows a transport system arrangement according to various embodiments;

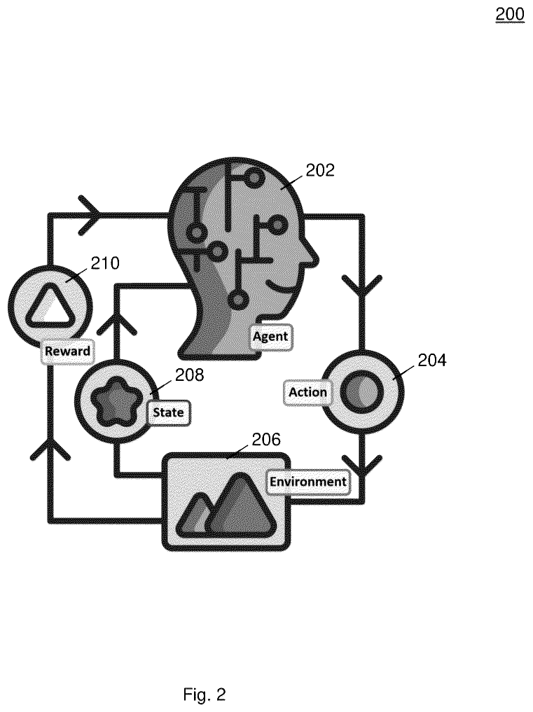

FIG. 2 shows an illustration of reinforcement learning according to various embodiments;

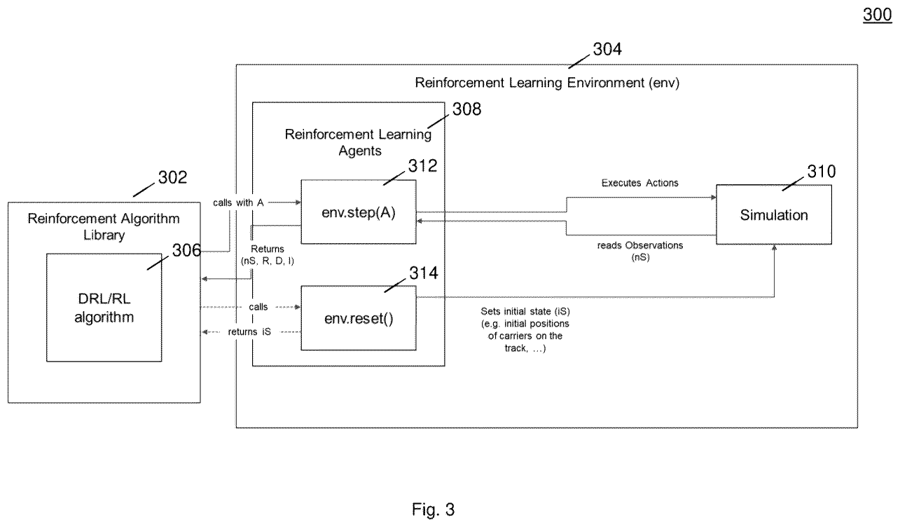

FIG. 3 shows an illustration of reinforcement learning method according to various embodiments;

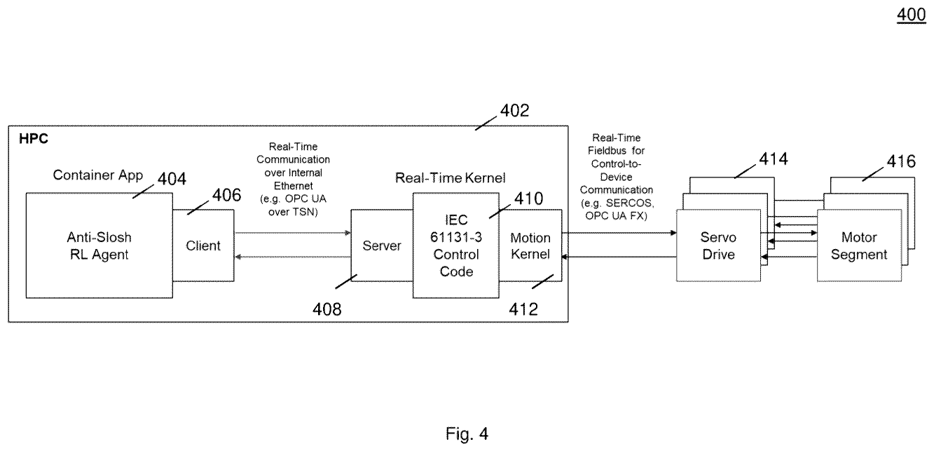

FIG. 4 shows an illustration of a control concept according to various embodiments;

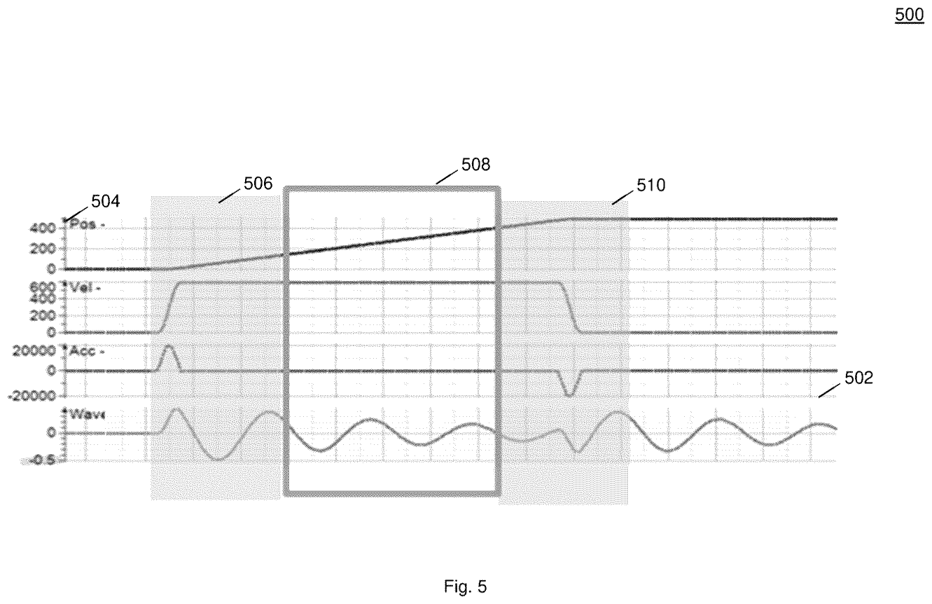

FIG. 5 shows an illustration of a segmented cam according to various embodiments;

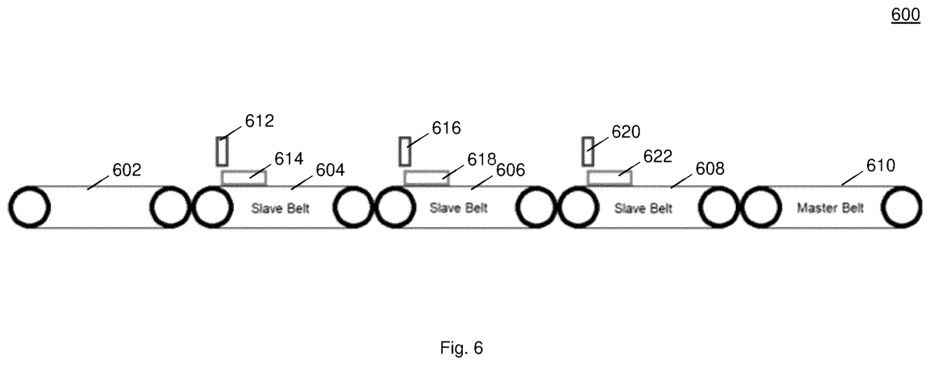

FIG. 6 shows an infeed system according to various embodiments;

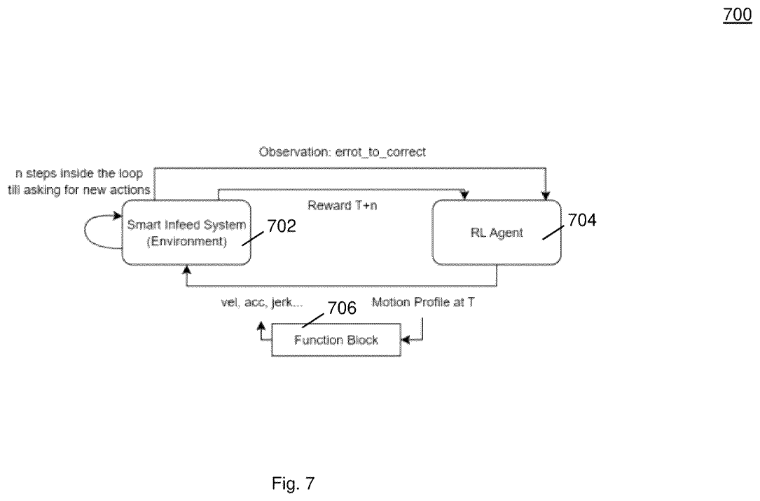

FIG. 7 shows an illustration of the reinforcement learning system according to various embodiments;

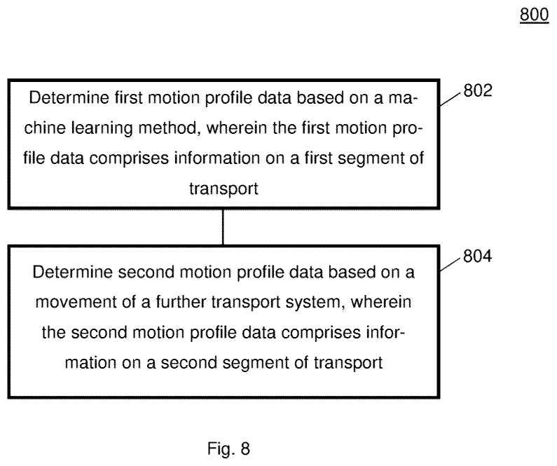

FIG. 8 shows a flow diagram illustrating a method for determining motion profile data for a transport system according to various embodiments; and

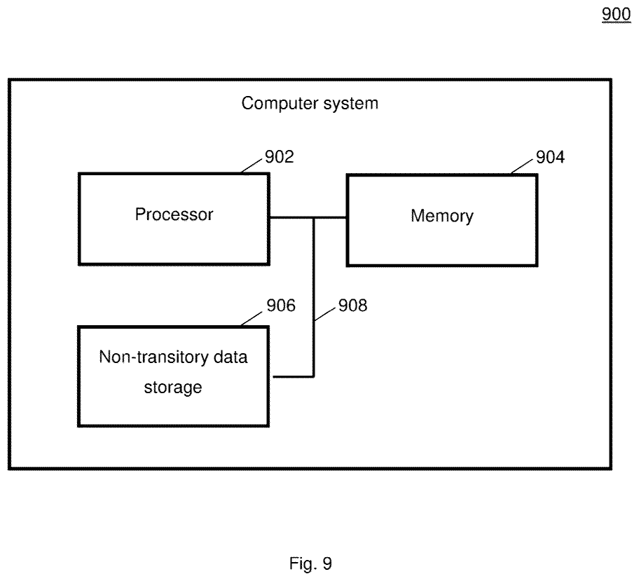

FIG. 9 shows a computer system according to various embodiments.

According to various embodiments, AI (artificial intelligence) improved general motion control (GMC) may be provided, for example for slosh reduction and multi-target-parameter optimization.

According to various embodiments, synchronous motion may be defined (or determined) to optimize movement in multi-target environments, for different formats, and in analytically not describable situations. For example, a container with liquid may be moved from position A to position B in a machine (in other words: using a transport system) without spilling the liquid.

Constraints may define or restrict the movement. For example, synchronous position movement for a specific area in the movement range may be required. It may be desired to achieve the movement in a minimum time to target, or to achieve an energy optimized movement.

A container may be moved. The shape of the container may positively or negatively influence the risk of spilling. The container may include a liquid. Viscosity of liquids may vary depending on compound (ingredients/recipe) of the liquid, and/or temperature (which may for example depend on the time of the day and/or processing ambient), and/or air pressure (which may for example depend on the ambient and/or geo location of the filling machine).

The liquid may include or may be sodium chloride (for example as an aqueous solution, for example with a mass percentage between 1% and 10%, for example 1%, or 2%, or 3%, or 5%, or 10%), and/or calcium chloride (for example as an aqueous solution, for example with a mass percentage between 1% and 10%, for example 1%, or 2%, or 3%, or 5%, or 10%), and/or potassium iodide (for example as an aqueous solution, for example with a mass percentage between 1% and 10%, for example 1%, or 2%, or 3%, or 5%, or 10%), and/or cesium chloride (for example as an aqueous solution, for example with a mass percentage between 1% and 10%, for example 1%, or 2%, or 3%, or 5%, or 10%), and/or sucrose (for example as an aqueous solution, for example with a mass percentage between 1% and 10%, for example 1%, or 2%, or 3%, or 5%, or 10%), and/or whole milk, and/or olive oil, and/or canola oil, and/or sunflower oil, and/or honey, and/or ketchup, and/or peanut butter, and/or pitch, and/or beer, and/or soda water, and/or sparkling water, and/or lemonade.

According to various embodiments, a machine learning based, for example AI-generated, “motion profile” (which may also be referred to as “motion profile data” or as “cam”) may be provided that allows synchronous movement (and optimized movement) in multi-target environments, for different formats, and in analytically not describable situations.

The motion profile may be segmented into a plurality of segments. Accordingly, the transport for which the motion profile is provided may be divided into a plurality of segments of transport. The segments of the motion profile may include an acceleration segment, and/or a continuous movement segment, and/or a deceleration/return segment.

Fixed parts of the motion profile may include a segment with synchronous movement with other mechanics (for example synchronous movement of the transport system with the further transport system). Inputs for the training/execution engine may include a constant velocity and/or pre-determined segment limits.

Variable parts of the motion profile may include an acceleration segment and/or a deceleration segment. Inputs for determining the variable parts may include the pre-defined segment limits. Outputs of the method for determining the motion profile data (in other words: outputs of the execution engine) may be provided separately for the acceleration segment, the synchronous segments, and the deceleration segment. Each segment may include data including an array (in other words: list) of position-points which may be interpolated in the motion kernel (for example with a polynomial of fifth degree, which may be referred to as Poly5).

For example, an anti-slosh movement (or motion) may be determined, wherein the method may provide an AI defined motion profile that moves a container without spilling a liquid in the container, considering different container shapes, fill levels, and/or liquid viscosities.

“AI defined motion profile” may be understood as a motion profile which is provided by AI, for example by a machine learning method which has been trained.

The inputs during training may include liquid parameters (for example viscosity and/or mass), container parameters (for example height, and/or fill height, and/or mass, and/or geometry of the container), ambient conditions (for example temperature and/or air pressure), segment border conditions for the segments of the profile that are to be determined by AI (and which may be referred to as AI segments; for example start and end conditions, for example x position at a start of the segment and/or velocity at a start of the segment and/or acceleration at a start of the segment, and/or jerk at a start of the segment and/or x position at an end of the segment and/or velocity at an end of the segment and/or acceleration at an end of the segment, and/or jerk at an end of the segment) and/or segment border conditions for a constant-vel segment (wherein for start and end the following values are provided: x, pos, vel, acc, jerk), and/or a slosh level measured by a sensor unit.

The motion definition may be done in an “pos over pos” diagram (instead of pos over time). This means the y coordinate is a representation of the slave's position and the x coordinate is a representation of the master's position. By doing so and not “pos over time” the velocity of the master axis can be increased while all the positions of the slave axis are calculated and operating still synchronously.

The output during operation (in other words, after training, and when using the machine learning method in actual operation; this phase may also be referred to as inference phase) may include a motion profile for AI segments (for example including interpolated position values), for example including segment border conditions (for example x, and/or position, and/or velocity, and/or acceleration, and/or jerk).

According to various embodiments, the training may include several steps.

In a first step of training, real measurement or data from a simulation model may be used. For example, data may be acquired using a slosh wave measurement system, for example an ultrasonic or laser-distance based measurement system. In n training runs with different liquids and with different defined (or arbitrary) movement, the real damping may be measured.

In a second step of training, a data driven simulation model or any other simulation model or any other simulation may be used. For example, a simulator may be used to simulate dynamical behavior of liquids.

In a third step of training, the actual reinforcement learning may be carried out. An (artificial) neural network (which may be used for control after training) may be trained, for example by trial and error or by using an optimization method, based on training data. The observation for training may include or may be the level of slosh on different movements. The actions for the reinforcement learning method may include or may be providing different motion profiles. The reward function may include or may be related to minimizing the level of slosh.

Reinforcement learning (RL) is an area of machine learning concerned with how intelligent agents ought to take actions in an environment in order to maximize the notion of cumulative reward. Reinforcement learning is one of three basic machine learning paradigms, alongside supervised learning and unsupervised learning.

FIG. 2 shows an illustration 200 of reinforcement learning, illustrating an agent 202, an action 204, an environment 206, a state 208, and a reward 210.

More details on the reinforcement learning according to various embodiments are provided in FIG. 3 below.

Reinforcement learning may differ from supervised learning in not needing labelled input/output pairs be presented, and in not needing sub-optimal actions to be explicitly corrected. Instead, the focus of reinforcement learning may be on finding a balance between exploration (of uncharted territory) and exploitation (of current knowledge).

According to various embodiments, a commonly used RL method may be used, for example one of the following: A2C, A3C, DQN, Impala, MARWIL, PPO.

According to various embodiments, a slosh-reduction agent may be provided based on a RL method. The observations for the RL method may include one or more of the following: liquid viscosity, ambient temperature, container shape, container height, liquid fill level, segment limits (x, y, vel, acc), slosh-level. The actions for the RL method may include defining acceleration/deceleration segment position values (for example in the form of an array). The reward model for the RL method may include one or more of the following: information on whether the target position is reached; level of liquid remaining in the container (for example after the movement or during the movement), level of slosh (wherein a lower level is better), information on continuous segment limit passing, and a Y (in other words: lateral) distance between set position points.

According to various embodiments, a data-driven simulation may be provided to facilitate the reinforcement learning. The data-driven simulation may include steps of data collection, data preprocessing, model development, model validation, and simulation and analysis.

In the step of data collection, data that represents the behavior of the system or process that is to be simulated may be collected. This data may be obtained from various sources, including sensors, historical records, and other sources.

In the step of data preprocessing, once the data is collected, the data may be cleaned and processed to ensure that it is accurate and consistent. This step may involve removing any outliers, filling in missing values, and normalizing the data.

In the step of model development, a model may be developed based on the preprocessed data. There may be several types of models that can be used, including statistical models, machine learning models, and other types of models.

In the step of model validation, once the model is developed, the model may be validated to ensure that it accurately reflects the behavior of the system or process being simulated. This may involve comparing the model predictions with actual data to see how well the model performs.

In the step of simulation and analysis, the validated model may be used to simulate the behavior of the system or process under different conditions. This may help identifying potential problems or optimizing the system or process to improve performance.

FIG. 3 shows an illustration 300 of reinforcement learning method (for example a learning architecture) according to various embodiments. In FIG. 3, the following formulas and abbreviations are used: A may denote an action to take; iS may denote an initial state; nS may denote a new state; R may denote a reward; D may denote “Done” (for example a flag indicating that a task is complete); I may denote debug information. A reinforcement algorithm library 302 may include a DLR (deep reinforcement learning)/LR (reinforcement learning) algorithm 306. A reinforcement learning environment 304, which may be referred to as “env” may include reinforcement learning agents 308 and a simulation block 310. The reinforcement learning agents 308 may include a module 312 for executing a step (which may be referred to as env.step(A)), and a module 314 for executing a reset (which may be referred to as env.reset( )). The reinforcement algorithm library 302 may call env.step (A) 312 with argument A. env.step (A) 312 may calculate R and D based on whatever is provided as nS. env.step (A) 312 may execute actions using simulation block 310, and env.step (A) may read observation (nS) from simulation block 310. env.step (A) 312 may return ns, R, D, and I to reinforcement algorithm library 302. The reinforcement algorithm library 302 may call env.reset( ) 314. env.reset( ) 314 may sets initial state (IS) (for example initial positions of carriers on the track) for the simulation module 310. env.reset( ) 314 may return iS to the reinforcement algorithm library 302.

Actions and observations may be specific to a motion application. Actions may be rather stable though, as actions are the parameters needed to generate a motion profile. An example of application-specific observations for a slosh-reduction agent are as follows:

Observations may include a viscosity of the liquid, an ambient temperature, a container shape, a container height, a liquid fill level, segment limits (for example x, y, vel, acc), and a slosh level.

Actions may include to define acceleration/deceleration-segment position-values (for example provided in an array).

A reward model may include a target position reached, a level of liquid remaining, a level of slosh (wherein the less the better), a continuous segment limit passing, and a y distance between set pos points.

According to various embodiments, training data and a simulation environment may be provided. A simulation engine may produce training data during simulation. The simulation engine may include a spline based interpolation engine to simulate the movement of the mechanics (for example including the container, and/or carrier, and/or flying knife), and to provide liquid behaviour simulation.

FIG. 4 shows an illustration 400 of a control concept according to various embodiments. A HPC (high performance computing) module 402 may include an anti-slosh RL (reinforcement learning) agent 404 and a client 406, a server 408, a real-time kernel 410, and a motion kernel 412. The client 406 and the server 408 may communicate via real-time communication over Internal Ethernet (for example OPC UA over TSN) or via shared memory.

One or more servo drives 414 may be in communication with one or more motor segments 416.

The motion kernel 412 may communicate with the one or more servo drives 414 via Real-Time Fieldbus for Control-to-Device Communication (for example SERCOS, or OPC UA FX).

The HPC 402 may map the trained RL agent to the real world, may map observations from the real system to the internal data structures of the RL agent and may map actions from the RL agent to PLC (programmable logic controller) functions.

The anti-slosh agent 404 may encapsulate the trained RL agent, and alternatively may be replaced with another RL agent.

The client 406 may include a client part of the interface, and may send requests to the PLC (Server) to execute actions and to read observations.

The server 408 may include a server part of the interface, may take requests and may execute them, i.e. may perform the actions (calling internal PLC functions) and may provide requested parameter values.

The real-time kernel 410 may include a control application, for example written in IEC 61131-3 control code, and may be responsible for executing motion jobs (for example cam execution with interpolated segments and cam segments), may configure the cams with relevant data (for example acceleration, deceleration, maximum velocity, jerk, segment limits), may trigger job execution and read values from the real system.

The motion kernel 412 may, based on the entered motion job (for example cam job), calculate the motion profile and may send set-pos values via SERCOS to the servo drives 414. Based on the entered motion command (for example acceleration, deceleration, maximum velocity, jerk), the motion kernel 412 may calculate the motion profile and may send set-pos values via SERCOS to the servo drives 414.

According to various embodiments, synchronous motion control with segmented movement may be provided where on ore more segments give freedom on the motion definition in the segment. For example, an overall position of an axis in a product cycle may be segmented in synchronous movement parts and parts/segments that just needs the “definition” of the segment-limit conditions (start/end of segment conditions). The exact cam/curve/profile “how to meet” the segment limits may be AI generated. According to various embodiments, AI-segments may be provided in segmented cams.

The segmented cam with AI-cam-segments may be provided on a belt/transport system side (for example anti-slosh, which may be seen as kind of master), as well as on dependent mechanic side (for example flying knife).

Segmented cams may be provided on various machines, for example flying shear/knife, crank, anti-slosh, multicarrier (with synchronous path/position), transport systems (belts, multicarrier) with following (synchronized) mechanics (in other words: with constraints on dynamic movement/behavior of following-mechanic).

According to various embodiments, probabilistic solution may be provided for problems which are hardly (or not at all) describable analytically (for example anti-slosh problems), or where analytical solutions are only possible for selected subcases, or where analytical solutions are not available yet (for example anti-slosh movement around multicarrier-curved segments).

FIG. 5 shows an illustration 500 of a segmented cam. A horizontal axis 502 may indicate time, and vertical axes 504 may indicate a position (for example of a container), velocity (for example of the container), acceleration (for example of the container), and wave (for example of a liquid in the container). A synchronous segment 508 may be provided between two less restricted segments 506 and 510. The synchronous segment may be a segment in which the transport system of the container is synchronous to another transport system, for example because a tool provided on the other transport system may manipulate the container while the container is moved using the transport system; accordingly, the motion profile of this segment may be determined based on a movement of the further transport system. The less restricted segments 506 and 510 may for example be acceleration or deceleration segments, and a motion profile for these segments may be determined based on a machine learning method (so that these segments may also be referred to as AI segments).

According to various embodiments, synchronous motion control with segmented movement systems with set-pos-chain coupling (following “slave” mechanic synchronized) may be provided. Dependent mechanics may define a movement for a complete “function/product cycle” (one, more, all segments of a segmented cam) even for non-velocity-constant movements. Synchronous “paths” may depend on mechanical constraints (acceleration/deceleration limits), on masses, on function type (e.g. handover of movable goods only in containers . . . ) and may be provided as input parameter to the system.

Set-pos-chain may be understood as the concept in motion control how a master can operate several (for example more than 100) slave axis in position synchronous mode. One key aspect to achieve this may be to connect master position with slave position (as a machine may even have more than one master or other e.g. event triggered motion sub-systems). The firmware engine calculating the slave positions (which may be referred to as “motion kernel”) may carry out cyclic checking this configuration of master-to-slave and cyclic calculating the slave positions according to the master position.

According to various embodiments, motion profiles for transport systems (for example belts, or multicarrier) with following (in other words: synchronized) mechanics (for example constraints on dynamic movement/behavior of following-mechanic) may be provided.

According to various embodiments, AI generated optimized/flexible motion profiles may be provided without the need for vel-constant synchro profiles (for example providing energy saving, faster returning to initial pos, and/or machine speed optimization).

For example, three AI segments (synchronous acceleration, return, and wait to safe energy) may be provided.

According to various embodiments, motion control areas with low to none tight position coupling (or high tolerance on mechanical position) may be provided. For example, the function to fulfill may be the “transport” function itself. It may have no (or limited) mechanical coupling. The coupling may not be on highly synchronous movements but rather on “hand-over” points, work-stations or via sensor-based independent movements.

According to various embodiments, motion profiles may be provided for product belts transporting goods on “jam”, outfeed belts, logistic systems, hoisting applications, or multicarrier applications (for example with stations as mechanical synchronization points).

According to various embodiments, multi-parameter optimization problems may be solved, for example based on time-to-target-position (for example minimal arrival time, in order to increase throughput), and/or under constraints (for example mechanical, for example friction/jerk, or physical, for example slosh), or based on energy optimization of movements.

According to various embodiments, multiple variant problems (for example optimization under specific situation for one or more multi-parameter problems defined by the user) may be provided.

According to various embodiments, sustainability may be increased, for example by energy optimization, and/or efficiency may be increased, for example by providing faster machine speeds, so that more products per minute (more throughput) may be provided. According to various embodiments, “Zero Engineering” may be provided: Analytically hardly describable problems may be solvable via probabilistic narrowing (for example using AI).

According to various embodiments, the machine learning method (in other words, the AI method) may be used in the control-loop on a realtime (RT) side of an implementation. The RL agent may be implemented on an RT side via driver for a RT system for an AI accelerator. Cyclic feedback (for example based on a fieldbus cycle) from a motion engine/RL agent and sensor feedback from a machine may be provided. This may provide minimized latency between AI and a motion kernel, so that for example life reaction on situations may be possible (for example instant cam on sensor based motion interruption or new set-pos-table). Furthermore, this may allow a fast switch on different agents/strategies (for example energy based or speed based), and/or a fast reaction on product change/format change (for example related to different liquid recipes), which may be suitable for Industry 4.0 and/or Batch size 1.

According to various embodiments, an optimized movement around a bend (in other words curve), for example at a multicarrier system, may be provided. For example, an anti-slosh movement of a container with a liquid around a curve may be provided.

According to various embodiments, different types of definition of the motion profile may be provided, for example interpolated set-pos-arrays, or analytical function definitions (for example like in VDI2143), wherein the respective definition may be provided per AI-defined segment including selection of mathematical laws and appropriate configuration of the mathematical law.

The mathematical law may be the “real” definition of the motion of a slave axis. For example, a slave axis may be moving according to a cam. The cam may be a software-defined curve. Cam and motion profile may be used as synonyms.

A cam (in other words: motion profile) may be built by several segments of motion definitions (in other words: cam-segments). Each segment may be defined in the standard case with a mathematical law (for example as defined in VDI2143).

According to various embodiments, analytical functional definitions (for the motion profile) may be provided for example according to VD2143 laws or by another suitable function definition, for example by a polynomial (or piecewise polynomial or polynomial spline) of degree 7 (which may be referred to as Poly7).

According to various embodiments, motion profiles may be provided for segmented cams with cam-laws, or for positioning laws or position-based motion definition.

According to various embodiments, motion profiles may be determined for a smart infeed system which is a library for serial running infeed belts with functions and methods that help to realize a product infeed.

FIG. 6 shows an illustration of an infeed system 600 with a first belt 602, a plurality of slave belts 604, 606, 608, and a master belt 610. A first sensor 612 may detect an item 614 on the first slave belt 604. A second sensor 616 may detect an item 618 on the second slave belt 606. A third sensor 620 may detect an item 622 on the third slave belt 608. The respective sensors 612, 616, 620 may determine the location of the items, and may correct their positions. For example, if an item is on a position further than expected, a negative correction may be provided. For example, if an item is on a position behind the expected position, a positive correction may be provided.

During normal operation (when no correction is necessary), all correction belts 604, 606, 608 (which may be referred to as CB or as slave belts) may run synchronously to the master belt 610 (which may be referred to as RB or as reception belt). A straight profile may be used for normal movement. A different motion profile, for example a non-straight profile, for example using a poly-5 motion profile (which may be a piecewise polynomial of degree 5, which may be referred to as a spline) may be used for correction. The belts may move synchronously when products are transferred from one belt to next one. No strictly synchronous motion is required when correction is made (for example, additional acceleration/deceleration may be provided).

The correction needs to be finished before the next product arrive on the correction belt. A commonly known dwell-to-dwell motion profile for correction may be the 5th degree polynomial, also called the 5th order polynomial or 3-4-5 polynomial, which may be used with cam calculators and in the world of servo drives.

The 5th degree polynomial may have a balanced profile of characteristic values and may be described as a “decathlete” among the motion laws.

A positive correction may include higher speeds of the slave belt in order to move the item on the slave belt faster. A negative correction may include lower speeds of the slave belt in order to move the item on the slave belt slower. The positive correction or negative correction may be provided as a RL-controlled correction using a poly-5 motion profile.

Assuming that the master belt's displacement is yₘ, with a velocity of vₘ and a correction belt's displacement of y_{c}, the following equations hold:

$$\text{?}$$

$$\text{?} \text{indicates text missing or illegible when filed}$$

The following constraints may hold true:
Initial position and velocity of CB: displacementₜ₌₀=0, velocityₜ₌₀=vᵣ, which leads to a₀=0, a₁′=1.
End position and velocity of CB: displacement_{t=T}=c,velocity_{t=T}=vᵣ, where c is defined as the maximum displacement during correction.
4 constraints: velₘᵢₙ≤velocity≤velₘₐₓ,accₘᵢₙ≤acceleration≤accₘₐₓ, wherein these limits may be given by a user's configuration.

Based on the above, there are 6 parameters and 4 equations, which in the end leads to 2D action space.

By defining the appropriate reward function, the best coefficients may be found.

Since a₀=0, a₁′=1, the following may hold true:

$$displacement = {v}_{m} t + {a}_{2} {v}_{m}^{2} {t}^{2} + {a}_{3} {v}_{m}^{3} {t}^{3} + {a}_{4} {v}_{m}^{4} {t}^{4} + {a}_{5} {v}_{m}^{5} {t}^{5}$$

$$velocity = {v}_{m} + 2 {a}_{2} {v}_{m}^{2} t + 3 {a}_{3} {v}_{m}^{3} {t}^{2} + 4 {a}_{4} {v}_{m}^{4} {t}^{3} + 5 {a}_{5} {v}_{m}^{5} {t}^{4}$$

$$acceleration = 2 {a}_{2} {v}_{m}^{2} + 6 {a}_{3} {v}_{m}^{3} t + 124 {a}_{4} {v}_{m}^{4} {t}^{2} + 205 {a}_{5} {v}_{m}^{5} {t}^{3}$$

When the correction is finished, the following may hold true:

$${v}_{m} T = c - error {\to }^{yields} T = \frac{c - error}{{v}_{m}}$$

$${a}_{2} {v}_{m}^{2} {T}^{2} + {a}_{3} {v}_{m}^{3} {T}^{3} + {a}_{4} {v}_{m}^{4} {T}^{4} + {a}_{5} {v}_{m}^{5} {T}^{5} = error {\to }^{yields} {a}_{2} + {a}_{3} {v}_{m} T + {a}_{4} {v}_{m}^{2} {T}^{2} + {a}_{5} {v}_{m}^{3} {T}^{3} = error$$

$$2 {a}_{2} {v}_{m}^{2} T + 3 {a}_{3} {v}_{m}^{3} {T}^{2} + 4 {a}_{4} {v}_{m}^{4} {T}^{3} + 5 {a}_{5} {v}_{m}^{5} {T}^{4} = 0 {\to }^{yields} 2 {a}_{2} + 3 {a}_{2} {v}_{m} T + 4 {a}_{4} {v}_{m}^{2} {T}^{2} + 5 {a}_{5} {v}_{m}^{3} {T}^{3} = 0$$

Assuming that [a₂, a₃] is the 2D action generated by the agent, the following relationship may be obtained:

$${a}_{4} = \frac{5 error - 3 {{a}_{2} ( c - error )}^{2} - 2 {{a}_{3} ( error )}^{3}}{{( c - error )}^{4}} ,$$

$${a}_{5} = \frac{- 4 error + 2 {{a}_{2} ( c - error )}^{2} + {{a}_{3} ( c - error )}^{3}}{{( c - error )}^{5}}$$

In the following, reinforcement learning in the smart infeed system according to various embodiments will be described.

FIG. 7 shows an illustration 700 of the reinforcement learning system according to various embodiments. A smart infeed system 702, a RL agent 704, and a function block 706 may be provided. T may indicate a time step.

There may be only one function block (FB) 706 which has control over all correction belts, which corresponds to a single-agent in the RL simulation. Alternatively, multi-agent reinforcement may be provided and a mapping to real PLC hardware may be provided.

“Mapping” is referring to the possibility to have more than one agent and the definition of a relation of every agent and its subsystem it is responsible to control.

There may be no mathematical mapping. In case of multi-agent reinforcement learning, there may still be a single function block that interacts with the AI (artificial intelligence) side. However, on the AI side, there may be multiple agents that can generate actions. These actions may then be combined according to a predefined policy (for example, the individual agents may then be responsible for a disjoint set of actions). The environment and state/observation may the same for all agents.

According to various embodiments, the following fixed poly-5 MP (motion profile) may be used in the smart infeed system may be as follows:

$${y}_{c} = {y}_{m} + error = {y}_{m} + ( 10 {y}_{m}^{3} - 15 {y}_{m}^{4} + 6 {y}_{m}^{5} )$$

If a CB does not ask for action, it may move as (in other words: synchronously to) the master belt. If a CB asks for action, motion profiles may be generated.

If the following requirements are fulfilled, then a new action may be generated: a new product (in other words: an item) is detected by the sensor, and there is no existing MP to correct the error of this product.

Table 1 shows details on the state according to various embodiments. A discrete state space may be provided.

TABLE 1
State [symbol]
State

AskForAction: [Boolean * num_belts]
If CB not ask for action, move as master belt
If CB ask for action, generate motion profiles

If the following requirements are fulfilled, then a new action may be taken: A new product is detected by the sensor; and there is no existing MP (motion profile) to correct the error of this product.

Table 2 shows details on the action according to various embodiments. There may be six parameters (a₀, a₁, a₂, a₃, a₄, a₅) within the poly-5 MP of correction belt, which define an error:

$$error = {a}_{0} + {a}_{1} x + {a}_{2} {x}^{2} + {a}_{3} {x}^{3} + {a}_{4} {x}^{4} {a}_{5} {x}^{5} .$$

a₀ and a₁ may be derived from two constraints, and RL may be used to compute the remaining parameters a₂, a₃, a₄ and a₅. Velocity, acceleration, and jerk may then be derived from this motion profile to control the correction belts.

TABLE 2
Action [symbol]
Action

A array of shape (1, 2): [a2, a3]
Derive a4, a5 from existing constraints
These 4 parameters define poly-5 MP

Table 3 shows details on the reward according to various embodiments. The reward is updated when a product is detected, and then it is asked for new actions to generate the MP for this product.

TABLE 3
Reward [symbol]
Reward

Error: + for low error bias, vice verse
Velocity: + for low velocity bias, vice verse
Counter: + for throughputs, − for collision
Limit: − if max/min vel, acc are exceeded

Table 4 shows details on the observation according to various embodiments. There may be no constraint on jerk, so there may not be a need to create observations for that. The parameter c may be used to indicate that the correction should only happen within this distance. For any movement beyond this distance c, the product should move synchronously with the master belt.

TABLE 4
Observation [symbol]
Observation

Kinematic: normal velocity
Product: error to correct
System: c (max displacement for correction)

There may be 6 parameters within the poly-5 MP of correction belt:

$$error = {a}_{0} + {a}_{1} x + {a}_{2} {x}^{2} + {a}_{3} {x}^{3} + {a}_{4} {x}^{4} + {a}_{5} {x}^{5}$$

a₀, a₁ may be derived from 2 constraints, and RL may be used to determine 4 parameters. Velocity, acceleration, jerk may then be derived from this motion profile to control correction belts.

When a new product is detected, the system may ask for new actions to generate the MP for this product and may also return the reward for previous action. It will be understood that this action and reward update may be not synchronized with the system update, so that a: multi-step learning may be provided.

There may be no constraint on jerk, so that it may not be necessary to create observations for jerk.

According to various embodiments, a dense reward may be provided. For example, an error corrected at the end of the MP may be used as a reward: rewardₚₒₛ=5−pos_{bias}. For example, a velocity at the end of the MP may be used as a reward:

$${reward}_{v e l} = 10 - \vert {vel}_{e n d} - v e {l}_{m a s t e r} \vert .$$

The end velocity may or may not be the same as master velocity, while the error doesn't have to be corrected completely in one correction belt.

According to various embodiments, sparse rewards may be provided as indicated in Table 5.

TABLE 5
Sparse rewards

| Events | Reward |
|---|---|
| Velocity Bias <100 | +5 |
| Velocity Bias <50 | +10 |
| Velocity Bias <10 | +20 |
| Velocity Bias <5 | +30 |
| Error Bias <20 | +10 |
| Error Bias <10 | +15 |
| Error Bias <5 | +20 |
| product within finger | +10 |
| product collision | −20 |
| vel/acc exceed max | −20 |
| vel/acc below min | −30 |
| backward movement | −50 |
| valid move/vel/acc | +5 |
| each step before | +0.2 |
| truncation | |

In Table 5, “product within finger” is related to smart infeed systems, where products are sent to reception belts, and wherein for example the distance the distance between each product is equal. Fingers are the baffles in reception belts which partition the reception belt into compartments.

Truncation in RL may refer to that certain boundary condition is reached, hence the current training may not be continued anymore; examples are time limit, or a robot going out of bounds.

In case two products are very close to each other, the truncation probability may be higher and the agent may be restarted.

FIG. 8 shows a flow diagram 800 illustrating a method for determining motion profile data for a transport system according to various embodiments. At 802, first motion profile data may be determined based on a machine learning method, wherein the first motion profile data includes or is information on a first segment of transport. At 804, second motion profile data may be determined based on a movement of a further transport system, wherein the second motion profile data includes or is information on a second segment of transport.

According to various embodiments, the second motion profile data may be determined so that the transport system moves in line with the further transport system.

According to various embodiments, the second motion profile data may be determined so that a handover of an item carried by the further transport system is provided to the transport system.

According to various embodiments, the first motion profile data and/or the second motion profile data may be defined using a spline.

According to various embodiments, the first motion profile data and/or the second motion profile data may be defined using an array of positions.

According to various embodiments, the first motion profile data may be determined based on minimizing a time.

According to various embodiments, the first motion profile data may be determined based on minimizing an energy consumption.

According to various embodiments, the first motion profile data may be determined based on minimizing slosh of a liquid provided in a container to be transported by the transport system.

According to various embodiments, the first motion profile data may provide (or describe or represent) at least one of an acceleration, a deceleration, or a return to a pre-determined position.

According to various embodiments, the further transport system may be configured to move a tool to manipulate an item carried by the transport system

According to various embodiments, the tool may include or may be at least one of a printer, a knife, or a tool to add a further item to the item.

FIG. 9 shows a computer system 900 with a plurality of computer hardware components configured to carry out steps of a computer implemented method for determining motion profile data for a transport system according to various embodiments. The computer system 900 may include a processor 902, a memory 904, and a non-transitory data storage 906.

The processor 902 may carry out instructions provided in the memory 904. The non-transitory data storage 906 may store a computer program, including the instructions that may be transferred to the memory 904 and then executed by the processor 902.

The processor 902, the memory 904, and the non-transitory data storage 906 may be coupled with each other, e.g. via an electrical connection 908, such as e.g. a cable or a computer bus or via any other suitable electrical connection to exchange electrical signals.

The terms “coupling” or “connection” are intended to include a direct “coupling” (for example via a physical link) or direct “connection” as well as an indirect “coupling” or indirect “connection” (for example via a logical link), respectively.

It will be understood that what has been described for one of the methods above may analogously hold true for the computer system 900.

According to various embodiments, an AI supported motion profile definition may be provided for (at least partially) fully synchronized motion in the area of general motion control. AI in the loop may be provided for motion control on the non-RT side. AI in the loop may be provided for motion control on the RT side.

According to various embodiments, machines may be optimized, for example to increase sustainability (for example by energy optimization), and/or efficiency (for example by faster machine speeds), may provide “Zero Engineering”, and may provide AI for motion control.

According to various embodiments, high performance computing (HPC) with equipped AI accelerator and AI software on GPOS part may be used. GPOS stands for “General Purpose operating system” and may for example be a Linux/Windows Operating systems. It differentiates for RTOS (Realtime operating system) by not having means in place (e.g. scheduler, task/thread definition) that utilizes the CPU resources best and in a way that it “enables/guarantees” the execution and timing of a part of its Firmware/software.

It will be understood that realtime does not make guarantees on execution. But it may optimize the execution and may have supervision on place to monitor severe deviations (execution timing violated) and reacts to it appropriately.

Features described in this specification and/or in the claims and/or shown in a figure shall be deemed combinable with and amongst each other also if their combination is not expressly described, to the extent that the combination is technically feasible. Features described in a certain context, embodiment, figure or claim shall be deemed separable from this claim, context, embodiment or figure and shall be deemed combinable with every other figure, claim, context or embodiment, to the extent that it is technically feasible. Embodiments and figures shall not be understood as being meant necessarily exclusive against each other. Features described as part of an embodiment or a figure shall be deemed separable from this embodiment or figure and shall be deemed combinable with features of other embodiments or figures, as far as technically possible. Descriptions of a method or procedure or a method step or a procedural step shall be understood also as a description of means for implementing the method or procedure or method step or procedural step and/or shall possibly also be understood as a description of an artefact made or modified by said method or procedure or method step or procedural step and/or shall possibly also be understood as a description of a data carrier holding program instructions of executable code adapted for implementing the method or procedure or method step or procedural step, and vice versa. In the present specification, references to the “invention” address the teaching as subjectively conceived by the inventors.

### LIST OF REFERENCE NUMERALS

100 transport system arrangement
102 transport system
104 first axis
106 plurality of items
108 further transport system
110 second axis
112 endless feed
114 logical encoder
116 coordinate system
200 illustration of reinforcement learning
202 agent
204 action
206 environment
208 state
210 reward
300 illustration of reinforcement learning method
302 reinforcement algorithm library
304 reinforcement learning environment
306 DLR/LR algorithm
308 reinforcement learning agents
310 simulation block
312 module for executing a step
314 module for executing a reset
400 illustration of a control concept according to various embodiments
402 HPC module
404 anti-slosh RL agent
406 client
408 server
410 real-time kernel
412 motion kernel
414 one or more servo drives
416 one or more motor segments
500 illustration of a segmented cam
502 horizontal axis
504 vertical axes
506 less restricted segment
508 synchronous segment
510 less restricted segment
600 infeed system
602 first belt
604 first slave belt
606 second slave belt
608 third slave belt
610 master belt
612 first sensor
614 item on the first slave belt
616 second sensor
618 item on the second slave belt
620 third sensor
622 item on the third slave belt
700 illustration of the reinforcement learning system according to various embodiments
702 smart infeed system
704 RL agent
706 function block
800 flow diagram illustrating a method for determining motion profile data for a transport system according to various embodiments
802 step of determining first motion profile data based on a machine learning method, wherein the first motion profile data includes or is information on a first segment of transport
804 step of determining second motion profile data based on a movement of a further transport system, wherein the second motion profile data includes or is information on a second segment of transport
900 computer system according to various embodiments
902 processor
904 memory
906 non-transitory data storage
908 connection

1. Method for determining motion profile data for a transport system, the method comprising:
determining first motion profile data based on a machine learning method, wherein the first motion profile data comprises information on a first segment of transport; and
determining second motion profile data based on a movement of a further transport system, wherein the second motion profile data comprises information on a second segment of transport.

2. The method of claim 1,
wherein the second motion profile data is determined so that the transport system moves in line with the further transport system.

3. The method of claim 1,
wherein the second motion profile data is determined so that a handover of an item carried by the further transport system is provided to the transport system.

4. The method of claim 1,
wherein the first motion profile data and/or the second motion profile data is defined using a spline.

5. The method of claim 1,
wherein the first motion profile data and/or the second motion profile data is defined using an array of positions.

6. The method of claim 1,
wherein the first motion profile data is determined based on minimizing a time.

7. The method of claim 1,
wherein the first motion profile data is determined based on minimizing an energy consumption.

8. The method of claim 1,
wherein the first motion profile data is determined based on minimizing slosh of a liquid provided in a container to be transported by the transport system.

9. The method of claim 1,
wherein the first motion profile data provides at least one of an acceleration, a deceleration, or a return to a pre-determined position.

10. The method of claim 1,
wherein the further transport system is configured to move a tool to manipulate an item carried by the transport system.

11. The method of claim 10,
wherein the tool comprises at least one of a printer, a knife, or a tool to add a further item to the item.

12. Non-transitory computer-readable medium comprising instructions which,
when executed by a computing system, make the computing system carry out a method for determining motion profile data for a transport system, the method comprising:
determining first motion profile data based on a machine learning method, wherein the first motion profile data comprises information on a first segment of transport; and
determining second motion profile data based on a movement of a further transport system, wherein the second motion profile data comprises information on a second segment of transport.

13. Data processing apparatus configured to carry out a method for determining motion profile data for a transport system,
the method comprising:
determining first motion profile data based on a machine learning method, wherein the first motion profile data comprises information on a first segment of transport; and
determining second motion profile data based on a movement of a further transport system, wherein the second motion profile data comprises information on a second segment of transport.

14. Transport system, comprising a control unit configured to determine a motion profile data for the control system based on a method for determining motion profile data for a transport system,
the method comprising:
determining first motion profile data based on a machine learning method, wherein the first motion profile data comprises information on a first segment of transport; and
determining second motion profile data based on a movement of a further transport system, wherein the second motion profile data comprises information on a second segment of transport.

15. The transport system of claim 14, wherein the transport system is configured as a multicarrier system.
